(19) United States
(12) Patent Application Publication
(10) Pub. No.: US 2007/0038674 A1
(43) Pub. Date: Feb. 15, 2007

(54) System and method for securely analyzing data and controlling its release

(76) Inventor: Arturo Bejar, Saratoga, CA (US)

Correspondence Address: INNOVATION PARTNERS, 540 UNIVERSITY DRIVE, SUITE 300, PALO ALTO, CA, 94301, US

(21) Appl. No.: 11/502,976

(22) Filed: Aug. 11, 2006

Related U.S. Application Data
(60) Provisional application No. 60/707,785, filed on Aug. 12, 2005.

(51) Int. Cl. G06F 17/00

(52) U.S. Cl. 707/104.1

(57) ABSTRACT

A system and method allows data to be shared for analysis without compromising the security of all the data, while allowing the analysis to proceed.

### RELATED APPLICATION

This application claims the benefit of attorney docket number 1482, U.S. Provisional Patent Application Ser. No. 60/707,785 entitled, “Method and Apparatus for Securely Analyzing Data and Controlling Its Release” filed by Arturo Bejar on Aug. 12, 2005, having the same assignee as this application, and is hereby incorporated by reference herein in its entirety.

### FIELD OF THE INVENTION

The present invention is related to computer software and more specifically to cryptography computer software.

### BACKGROUND OF THE INVENTION

Companies store data in databases or other repositories. It can be desirable to analyze certain data among two or more companies. To do so, however, the data from one company would have to be released to another company, the data analyzed, and action taken according to the analysis. For example, it can be desirable to correlate product purchases made by various customers of different companies to identify those products from each of two or more different companies that customers tend to purchase both of. Customers who purchased one such product, but not the other, can then be contacted to purchase the other correlated product.

Although it can be helpful to share data among various entities, it can compromise the security of the data to do so and so many companies will not participate in such activity by sharing their data. Furthermore, such sharing can be far more beneficial to one company than another, and so an agreement to share data with uncertain benefits of such data sharing can also inhibit a company's desire to share its data. However, parties sharing data may need more than an offer to negotiate when the benefit to each party of the sharing arrangement is identified.

Some parties may not wish to share data with the parties with whom such sharing would be beneficial, because they do not wish to provide the other party or parties with basic business information that could be obtained from their data, for example the name of the two correlated products. Such companies may pass up other, more specific benefits of data sharing because they cannot bear to provide such basic business information to another party, such as a competitor.

When data, such as the identity of customers, is shared, other information related to the shared information may be in a state of flux. Although it may be desirable to freeze certain other related information, the normal business operations of the company supplying the data may cause the related data to change.

What is needed is a system and method that can allow data to be shared for analysis beyond identification of matches or close matches, that allows the parties supplying the data to control its release, even until after the benefits to all parties of the sharing have become clearer, but allows such control to proceed in an enforceable manner in an agreed upon way, allows the data to be preserved at the time the sharing operations commence, and can provide specific benefits of data sharing while hiding basic business information from one or more parties.

### SUMMARY OF INVENTION

A system and method allows parties to share data by selecting it and transforming some or all of it in a manner that makes its detection difficult or impossible. The parties then provide the transformed data, and optionally other data which may or may not be transformed, to one of the parties or to a third party, who may perform analysis on the data. The analysis may consist of matching transformed data, and/or additional analysis on either the transformed data or untransformed data provided with the transformed data. The transformation of some or all of the data may be made in such a manner that the actual value of the data is obscured, but statistical and/or mathematical analysis is still possible on such data. The ability to analyze such data transformed in this manner may be obscured from the third party, the other parties who may receive such data, or both. Some or all results of the matching or other analysis, may be provided to the parties, optionally, along with the transformed and any untransformed data provided with the transformed data, or the results and transformed and any untransformed data provided with the transformed data may be provided to a fourth party with the parties supplying the data receiving only summary information regarding the results of the analysis or not information at all. If additional data release is desirable, for example, by releasing untransformed versions of some or all of the transformed data, the parties can elect to release such data after they have seen the results of the analysis. If desired, the parties can hide certain data included with the transformed data, and that will not be used in the analysis, by encrypting it using a secret key that is shared among the parties to allow them to access the data released by the party performing the analysis. If desired, different portions of the data can be encrypted using different keys, and those keys shared by the parties only after the results of the analysis are provided, allowing selective release of the data, while preserving its contents against subsequent change.

### BRIEF DESCRIPTION OF THE DRAWINGS

FIG. 1 is a block schematic diagram of a conventional computer system.

FIG. 2, consisting of FIGS. 2A, 2B and 2C is a flowchart illustrating a method of analyzing data according to one embodiment of the present invention.

FIG. 3 is a block schematic diagram of a transformed data record according to one embodiment of the present invention.

FIG. 4 is a table mapping transformed data to untransformed data according to one embodiment of the present invention.

FIG. 5 is a block schematic diagram of a system for securely transforming and providing the transformed data for analysis with that provided by other parties, receiving results, providing some or all of the untransformed data and processing data received from other parties according to one embodiment of the present invention.

FIG. 6 is a block schematic diagram of a system for analyzing transformed data records from two or more parties according to one embodiment of the present invention.

FIG. 7 is a block schematic diagram of a system for analyzing transformed data records received from multiple parties and providing results to any one or more of such parties or to a fourth party according to one embodiment of the present invention.

### DETAILED DESCRIPTION OF A PREFERRED EMBODIMENT

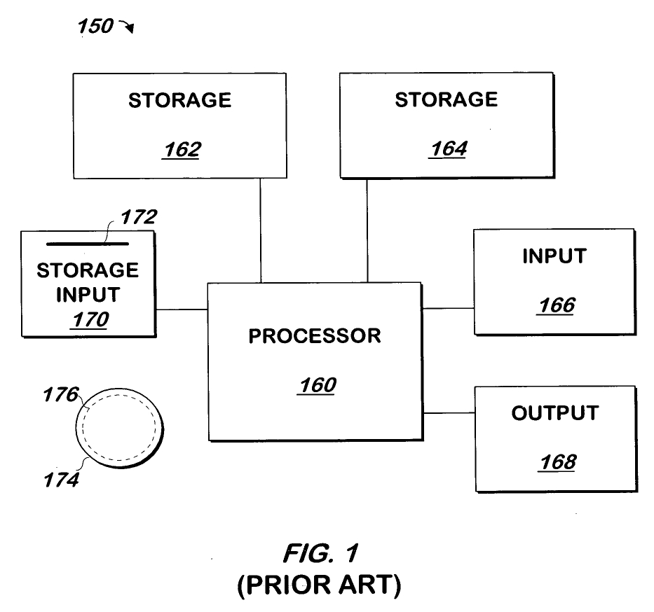

The present invention may be implemented as computer software on a conventional computer system. Referring now to FIG. 1, a conventional computer system 150 for practicing the present invention is shown. Processor 160 retrieves and executes software instructions stored in storage 162 such as memory, which may be Random Access Memory (RAM) and may control other components to perform the present invention. Storage 162 may be used to store program instructions or data or both. Storage 164, such as a computer disk drive or other nonvolatile storage, may provide storage of data or program instructions. In one embodiment, storage 164 provides longer term storage of instructions and data, with storage 162 providing storage for data or instructions that may only be required for a shorter time than that of storage 164. Input device 166 such as a computer keyboard or mouse or both allows user input to the system 150. Output 168, such as a display or printer, allows the system to provide information such as instructions, data or other information to the user of the system 150. Storage input device 170 such as a conventional floppy disk drive or CD-ROM drive accepts via input 172 computer program products 174 such as a conventional floppy disk or CD-ROM or other nonvolatile storage media that may be used to transport computer instructions or data to the system 150. Computer program product 174 has encoded thereon computer readable program code devices 176, such as magnetic charges in the case of a floppy disk or optical encodings in the case of a CD-ROM which are encoded as program instructions, data or both to configure the computer system 150 to operate as described below.

In one embodiment, each computer system 150 is a conventional SUN MICROSYSTEMS ULTRA 10 workstation running the SOLARIS operating system commercially available from SUN MICROSYSTEMS, Inc. of Mountain View, Calif., a PENTIUM-compatible personal computer system such as are available from DELL COMPUTER CORPORATION of Round Rock, Tex. running a version of the WINDOWS operating system (such as 95, 98, Me, XP, NT or 2000) commercially available from MICROSOFT Corporation of Redmond Wash. or a Macintosh computer system running the MACOS or OPENSTEP operating system commercially available from APPLE COMPUTER CORPORATION of Cupertino, Calif. and the NETSCAPE browser commercially available from NETSCAPE COMMUNICATIONS CORPORATION of Mountain View, Calif. or INTERNET EXPLORER browser commercially available from MICROSOFT above, although other systems may be used.

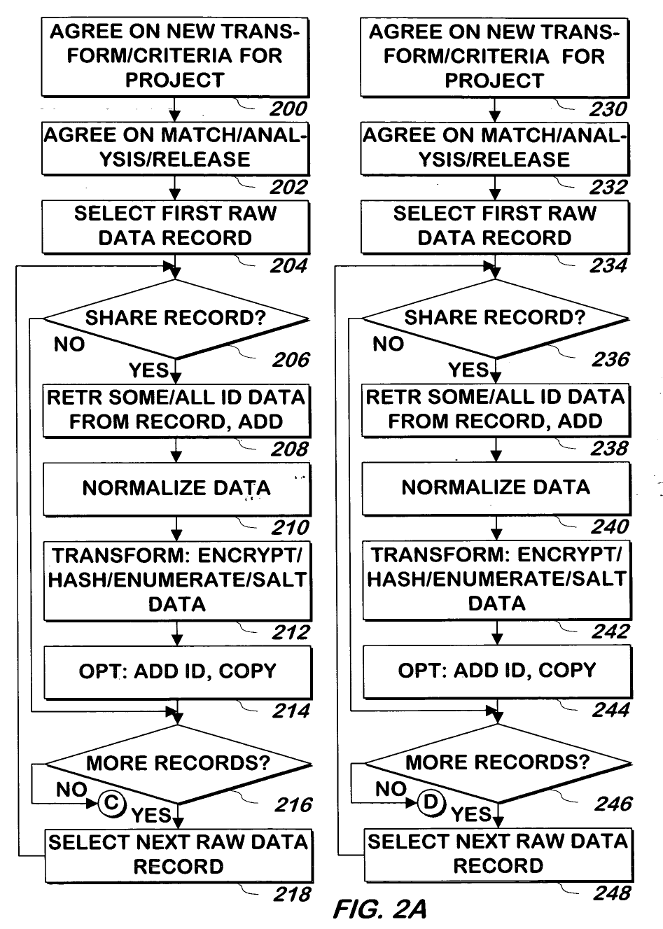

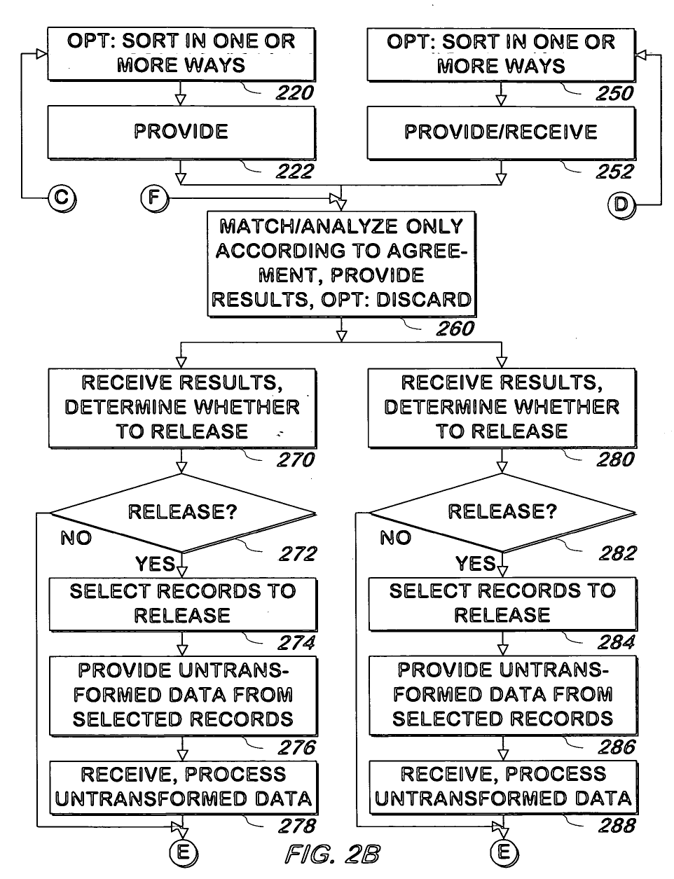

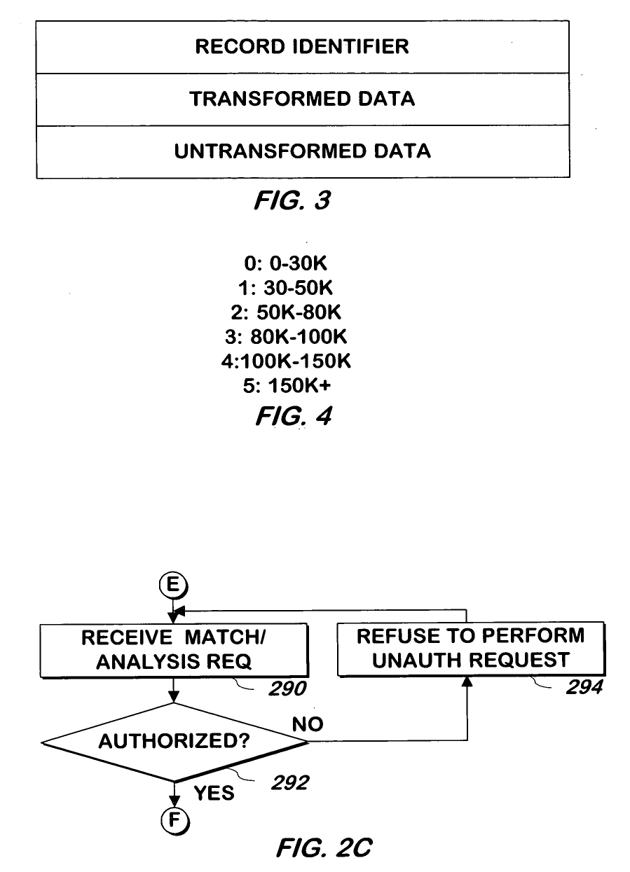

Referring now to FIG. 2, consisting of FIGS. 2A, 2B and 2C, a method of analyzing data is shown according to one embodiment of the present invention. The Figure shows the method for two parties who have data to share and do so with each other via a third party, although more than two parties may share data in a similar fashion or the parties may share data only with yet another party who provides data, and the data may be shared without the use of the third party as will be noted below.

As described herein, the data that is available to be shared may be arranged as several records, with one record per entity that is described by the data. In one embodiment, an entity is a person, and each record therefore corresponds to information about that person, however, entities may be companies, animals, buildings, or anything else. Each data record has one or more fields and may be arranged in a conventional database. Referring momentarily to FIG. 3, as will be described in more detail below, the data for an entity is added to a transformed data record, with each transformed data record 300 containing data in two forms: some or all of the fields in each data record may be transformed as described below and stored as transformed data or fields 310. Such data is characterized by the fact that at least some of the information is transformed in a manner that makes ascertaining its actual value difficult or impossible by a party that does not have access to the details of the transformation. The data as it exists before the transformation may be referred to herein as an “untransformed data record,” although such data may, in fact, come from several records. The information transformed may be a field of the untransformed data record, or such a field may be split into pieces and only one or some of the pieces is transformed. Some or all of the remaining fields of an untransformed data record may be copied into the corresponding transformed data record without transformation, causing the data in such fields to be untransformed data 320. A unique identifier 330 may be part of each transformed data record 300.

As described herein, each of two or more parties takes its untransformed data records, and uses them to build a transformed data record. The transformed data records from several parties are used to attempt to identify matches between transformed fields, untransformed fields or both of these, of the transformed data records, or to perform other analysis on the transformed fields or untransformed fields, or both, from the transformed data records. As described herein, both the untransformed data 320 and the transformed data 310 are arranged as records 300, each record containing data related to an entity and there may be many such records provided by each party. However, other data structures may be used, and the data structures may correspond to other things, such as transactions.

Referring again to FIG. 2A, in one embodiment, steps 200-222 are performed by one party, and steps 230-252 are performed by another party, with steps 230-252 being similar or the same as steps 200-222, except that steps 200-222 are performed by one party or by one party on its data and steps 230-252 are performed by another party or the other party on its data. Two parties are described herein, however, any number of parties may be used according to the present invention.

The parties agree in steps 200 and 230 on transformation information that will be used to transform the data as described below and optionally, the criteria used to select data records to share. In one embodiment, transformation information may be a shared secret, transformation method such as a hash or encryption technique and key or keys, salt, or other transformation information that each will use to transform their data before it is used for sharing. In one embodiment, the transformation information for an analysis project is different each time any one or more of the following changes: the parties, the data any party contributes or the transformation method used for any field of the untransformed data. As used herein, such transformation information is referred to as “nuveau” to indicate that it is different for different data, parties or transformations. The use of nuveau transformation information prevents the analysis of one or more of the party's data with that of a party who has not been authorized to participate by at least one of the parties sharing the transformation information.

The transformation information agreed upon in steps 200, 230 may include normalization details as described in more detail below. Normalization details may include the removal of leading or trailing spaces or other characters, padding details and characters, and other similar details used as described below.

Steps 200, 230 may include meta data that describes what each of their fields is or should be named to allow the analysis to proceed. In one embodiment, the parties also agree on the match or other analysis to be performed 202, 232. Steps 202, 232 may be performed at any time, but the parties may agree on which fields of the transformed data records will be used to analyze the transformed data and the type of analysis to be performed. In one embodiment, the comparison or other analysis to be performed in steps 202 and 232 is different from those used in a previous analysis or with data from a different set of two or more parties and may be different with each such analysis or set of parties if desired. As noted below, the analysis can be strictly limited to that agreed in advance by the parties, and that analysis may be less than all of the analysis possible on the data, to allow, for example, other data to be provided with the data being analyzed, but to ensure that the other data will not be analyzed without the permission of all of the parties that supplied the data being analyzed.

In one embodiment, steps 202, and 232 may include identifying rules under which the data corresponding to the analysis will be released. The rules may include any fields to be released and the conditions under such release will be permitted. For example, the parties may determine that a specific portion or all of each transformed data record having a specific field that matches will be released to any party for which the number of such records is not more than ten percent of the transformed records supplied by that party and not less than two percent of the transformed records supplied by that party.

The data to be released may include some or all of the transformed data records, some or all of the untransformed data records, or other information that may be related to either of such records, but not actually including such data records. For example, the parties may agree that the data to be released is the percentage of their own records in which two fields match one another, but that none of the information from any of the transformed data records or untransformed data records will be released. Or the parties may agree that the data to be released will be the transformed social security field and the untransformed age from any record for which the transformed social security number field from one party does not match the transformed social security number from a record of any other party.

In one embodiment, the parties do not contribute all of their data to the analysis. Instead, each party selects the data records they will share for the analysis and/or each party selects the fields in the untransformed data records to include, either in transformed or untransformed form, in its transformed data records. In such embodiment, each party selects 204, 234 the first untransformed data record and determines whether the record should be shared 204, 234. In one embodiment, all records are records that should be shared, and in another embodiment, a record should be shared if it meets the criteria agreed upon in step 200, 230. If the record is not a record that should be shared 206, 236, the method continues at step 216, 246, respectively. If the selected record is a record that should be shared 206, 236, some or all of the data is retrieved from the untransformed data record 208, 238 and added to a corresponding transformed data record. The data to be retrieved and added is determined according to the agreement made in steps 200, 230. As described below, the data is copied into the transformed data record, normalized and transformed, although, in another embodiment, the normalization and transformation may occur before the data is actually written to the record.

Some or all of the fields in the transformed record are normalized 210, 240. The normalization of steps 210, 240 may be according to any normalization rules that allow parties that have the same or similar contents of a field to be transformed to produce the exact same data, such rules either being standardized rules or details agreed upon in steps 200, 230 as described above. For example, if the field contains a credit card number, spaces may be omitted or spaces between groups of four digits may be added if not already added, but more than one space between digits is removed. Dashes may be removed. Leading or trailing spaces or other characters may be removed or leading or trailing spaces may be added. In the case of a name, middle initials may be removed, or middle names may be converted to middle initials. The procedures used in the normalization of step 210 will match the procedures used in the normalization of step 240 performed by the other party with a different set of data to allow matches to occur where a match exists, but on the transformed data as described below. In one embodiment, data is normalized only for those fields that are to be matched or otherwise analyzed as described herein. In one embodiment, data is also normalized for any field that will be transformed.

Some or all of the normalized fields or non normalized fields in the transformed data record are transformed 212, 242. The transformation may include encrypting or hashing some or all of the data in each record, or performing any other transformation of the normalized data that causes it to appear differently than it appeared in its untransformed form. The transformation may be reversible, for example, by encrypting one or more fields or by simply adding 5 to a number field if the untransformed value of the field is under 100, and adding 20 if the untransformed value of the same field is 100 or more. The transformation may be irreversible, for example, using a one-way hash function. Any other method of transforming the data may be employed, including the use of a one time pad and XOR or any other conventional transformation, such as those described in Schneier, Applied Cryptography, (2d.ed., John Wiley & Sons, Inc., 1996 ISBN 0-471-12845-7), Ferguson and Schnieier, Practical Cryptography (John Wiley & Sons, Inc., 2003, ISBN 0-471-22357-3) and Wayner, Translucent Databases, (Flyzone Sr., LLC, 2002 ISBN 0-967-58441-8).

When a portion of the transformed data record is so transformed, the transformed version of the data is used to replace the untransformed data in the transformed data record. In one embodiment, fields that were normalized in step 210, 240, are transformed, but non-normalized fields may be transformed as well. A transformation may also include assigning the data to enumerated categories, and then replacing the data with a category enumerator. Referring momentarily to FIG. 4, an example transformation is shown that transforms a person's income into any of six categories is shown, with the category enumerator having a value 0 through 6, and replacing an entity's income.

Referring again to FIG. 2A, one embodiment as part of the transformation, a phrase may be added to one or more fields in order to “salt” the data: purposefully corrupting it in a reversible manner. For example, a fixed set of characters originally chosen at random may be added to the beginning, end or at a specified middle point to any field, before hashing or encrypting it.

Different fields of each transformed data record may be transformed in different ways. For example, in one embodiment, some data in each transformed data record is transformed in one way, for example, by salting it using a shared secret salt phrase, then hashing it using a secret key that is agreed upon in steps 200 and 230, and other data in the same transformed data record is transformed in another way, for example, by replacing the data with a category identifier. Other transformations may be performed in accordance with the agreement of steps 200 and 230, such as multiplying incomes by Pi, e, or 133, to disguise them from the third party who will receive the data, while still allowing mathematical functions to be performed. Because the transformations are agreed upon in steps 200, 230, the corresponding transformed data fields of each party may be transformed in the same manner. However, parties may transform corresponding fields (e.g. the entity's income) in different manners in order to include them in the transformed data records, but disguise them from all other parties. In one embodiment, some or all of the transformations may be described to the third party, but not to the other parties, to allow analysis on certain fields while masking the fields to the other parties.

In still other embodiments, the a party may transform fields in the transformed data records in different manners to allow that party's data to be used in analysis of data from different groups of parties. For example, party A may wish to provide data for analysis by party B (with the first group being parties A and B) and also for analysis by parties C and D (with the second group being parties A, C and D). Party A may transform some fields using a first manner (e.g. using a hash or encryption key) and other fields in a second manner (e.g. using a different hash or encryption key), and still other fields are transformed using both methods, so that some of the transformed fields are included in the transformed data records twice, transformed once using each manner). Party A agrees with party B that the first manner will be used, and agrees with parties C and D that the second manner will be used so that the other parties can transform their data in accordance with the agreed upon manner. This allows party A to share for analysis certain fields of its data with party B, and other fields with parties C and D, and still other fields with parties B, C and D, without providing an opportunity for the third party to use party A's data for analysis in an unauthorized fashion.

In another embodiment, different secrets may be used within the transformed data records supplied by each group to provide the capability to use different party's data for different analyses. Using the example described above, fields that are to be analyzed using data shared from party A and B are transformed using one manner agreed upon by parties A and B, fields that are to be analyzed using data shared from parties A, C and D are transformed in another manner agreed upon by parties A, C and D, and fields that are to be analyzed using data shared from parties A, B, C, and D are transformed in still another manner agreed upon by all of those parties. In such embodiment, the data is analyzed using the shared data from parties A, B, C, and D, (instead of using the data from A and B and then again using data from A, C and D) as described in the example above. Such an arrangement may be used to identify a brute force attack on the BIN number of a credit card, to prevent a party from attempting to use a sequential list of credit card numbers, or other list of credit card numbers having the same BIN number, across a larger group of merchants (who would be the parties). The BIN numbers may be hashed using a single key across transformed data records from a larger group of parties than those whose data will be used in other analyses. This allows a larger set of transformed data records for the detection of the brute force BIN attack than may be used in marketing analyses, for example.

As described herein, the parties agree upon the various transformation methods. However, in other embodiments, one party (or a non party, or a random number generator) designates the transformation methods, such as by specifying a hash or encryption key. There may be any number of parties, entities corresponding to transformed data records, third parties and non-parties, participating in the analysis as described herein.

In one embodiment, fields that will be matched or otherwise analyzed can be hashed using a shared, but otherwise secret (at least to the third party and to non-parties as well) key, and those that will not be matched or otherwise analyzed are encrypted. Chaining mode cypher techniques may be used to further mask any encrypted data.

In one embodiment, some of the transformations may be made using a single transformation method across some or all of the fields transformed for every transformed data record supplied by the party. For example, some of the fields in the transformed data records may be hashed and others may be encrypted, but the hash and encryption is the same hash or encryption using the same key for all data records. However, it is not necessary that this is the case, and different transformation methods may be performed for each transformed data record or for each group of transformed data records. For example, in one embodiment, the encrypted fields may be encrypted using a different key based on the value of one of the enumerated fields. If the field has one value in a data record, all encrypted fields in that data record may be encrypted using one key, and if the field has another value in a different data records, all encrypted fields in that other record are encrypted using a different encryption key. This allows the party providing the data to allow the third party to distribute the transformed data records with any analysis results, but the party supplying the data can determine whether to release the data in the encrypted fields at a later time, such as after the results of the analysis have been received, by selectively providing the appropriate one or more keys.

It isn't necessary to transform all of the data in the transformed data record. In one embodiment, some of the data in the transformed data record is normalized and transformed, some is transformed, some is not transformed, and some is normalized and not transformed. Other embodiments may employ any or all of these types of data in the transformed data records. The untransformed data in the transformed data record may describe the same entity as the transformed data, but may not be considered confidential without knowledge of the untransformed values of the data transformed in step 212 and 242. For example, the transformed data may be a person's name and credit card data, and untransformed data may be the age of the person corresponding to the record, which may not be considered confidential when the person's name and credit card data is unavailable, although such information may be confidential if the persons name and credit card information were otherwise available. In another example, untransformed data may include an indicator of whether the credit card had been fraudulently used in the past. Although this information may be considered sensitive or confidential, without knowledge of the transformed name and credit card number, the indicator by itself or with the remainder of the untransformed data in the record would not be considered to be confidential or sensitive.

Another way to describe the difference between at least some of the transformed data and the untransformed data in the transformed data record is that the release of the untransformed data would not violate any confidentiality provisions, laws or standards without the release of at least some of the untransformed version of the transformed data in the transformed data record. Still another way of describing the difference is that the untransformed data would not allow the entity's identity to be ascertained, or at least ascertained as part of a very small group relative to the number of records shared as described herein, as compared with at least some of the untransformed version of the transformed data, which could be so used.

It is not necessary to have any untransformed data in the data record, though at least some of the transformed data may still have the characteristics described above. In one embodiment, at least some of the transformed data will have the characteristics of the transformed data described above, but none of any of the untransformed data will have the characteristics of the transformed data described above.

In one embodiment, as part of steps 212, 242, some or all of the transformed fields may be transformed twice, once in an irreversible or reversible way, and then again in a reversible way, such as by encryption. This will allow the data to be used in the analysis with a different group of parties by removing the second transformation and then either using the transformed data with a different group of parties who only perform the first of the transformations for those fields, or who employ the first transformation and a different second transformation, such as encryption using a different key. The removal and optional retransformation may be performed by the party that performs the analysis, thus saving the bandwidth that would otherwise be required to provide data transformed differently for the second group to the party performing the analysis.

In one embodiment, the removal of the second transformation and optional retransformation is performed by the party performing the analysis using software, the source code for which that party does not have access. The software accepts the encryption key and only decrypts the data received from the party providing the key, and does not provide access to the key to the party performing the analysis.

A unique identifier for the transformed data record may be added to the transformed data record 214, 244 and some or all of the data corresponding to the transformed data records, including either or both of data that is in the transformed data record and data that is not, may be copied as part of steps 214, 244, in order to preserve it. In one embodiment, the data to be preserved is added directly to the transformed data records in the manner described above. Preservation of data can be helpful when the untransformed data is live data that may change at the place it otherwise would be stored from the time it is turned into a transformed data record. Data may be added for other purposes as well, such as for escrow purposes (a key can be provided to an escrow agent for release upon certain conditions, for example), or to allow the data to be audited at a later time. Such data can be encrypted or transformed in a manner that is not shared with any party and not shared with the third party, at least initially.

If there are more untransformed data records 216, 246, the next untransformed data record is selected 218, 248 and the method continues at step 206 or 236. If there are no more untransformed data records 216, 246, the method continues at steps 220, 250.

At steps 220, 250, the transformed data records may be sorted in one or more ways. Sorting the transformed data records may involve physically sorting the records, or building an index that logically sorts the records. Multiple indices may be built (e.g. one for each field) to facilitate matching and/or analysis on various fields. To sort the transformed records in more than one way involves building a logical table of record identifiers that is itself physically sorted based on the value of a field, and may contain the contents of the field. It isn't necessary for the transformed records to be provided in a sorted manner, as the receiving party may perform the sort for use in the matching or other analysis described below, or no sort may be performed.

The sorted transformed records (e.g. the transformed data records and the indices) may be provided 222, 252 by the parties to a trusted or not trusted third party, or all but one of the parties may provide the sorted, transformed data records to the remaining other party, which receives the transformed data records 252 and uses those transformed data records and its own transformed data records to perform the matching or other analysis described herein.

In one embodiment, the party receiving the data agrees to perform only the matching or other analysis of the data only in the manner authorized by the party providing the data. In such embodiment, step 222, 252 may include providing the identifiers of fields on which matching or analysis is permitted, and the type of analysis permitted for each such field. As described below, the trusted third party will only match or otherwise analyze data from a party in the manner in which it was authorized by the party supplying the data, and the trusted third party will refuse to perform unauthorized matching or analysis on any party's data. The parties may at the time they provide their transformed data records, simply authorize the party performing the matching or other analysis to perform a certain specified matches and/or analysis agreed upon in steps 202, 232 and the party performing such match or other analysis will perform such specified analysis and no other. Alternatively, the party performing the analysis will receive the transformed data records, and can receive analysis instructions from any of the parties at any time. The party performing the analysis will perform any analysis to the extent that it does not violate the permitted analysis provided by any party. For example, if parties A, B and C send transformed data records and parties A and B specify that analysis may be performed on fields 1, 2 and 3, but party C specifies that analysis may be performed on fields 1 and 2, the party performing the analysis will perform an analysis request made by party A on field 1 using data from parties A, B and C, but an analysis request made by party B on field 3 will only be performed using the data from parties A and B but not party C.

The transformed records from each party are then matched or otherwise analyzed 260. To match transformed records from one party with that from another party, a transformed record from the first party is selected, and an attempt is made to locate the field being matched in the sorted index from the other party. If found, and provided any other criteria in the match instructions are met, the record identifiers from each of the two records are added to a table of matching records. If there are other parties, the process is repeated using the same record from the first party and the index of the additional party. This process is repeated for all other parties. The next record of the first party is selected and the process is repeated for all the other parties. This selection of an additional record of the first party and repeating of the matching attempt process is repeated until an attempt to match all of the records of the first party with those of the others has been made.

The match may occur on any one or more fields, including fields that have been transformed. As long as the fields (or portions thereof) have been normalized and transformed in a manner that will allow the same untransformed fields to be identical or otherwise recognizable when transformed, transformed fields may be matched in this manner. As noted, the party performing the analysis may adjust any fields to allow them to be matched, using instructions provided by the party that provided the transformed data record.

The above technique is used to match a field from transformed data records from the first party with those of the other parties. If it is desired to match records of all parties among each other, the first party is then removed from consideration and if there is more than one party remaining for consideration, the first unmatched record of the next party is selected and the process is repeated using all parties other than those removed from consideration. The next unmatched record from such next party is selected and the process is repeated until all such unmatched records from such party have been processed, at which point that party is removed from consideration and the process described above is repeated for other parties not removed from consideration until there is only one party not removed from consideration.

The process may be repeated for each field being matched, until all of the fields being matched have been processed in this manner. As noted above, the party performing the matching or analysis described below will only perform such matching or analysis on a party's data if that party authorized the matching or analysis.

In one embodiment, each party is assigned a column in the table, and the table produced has, in at least two columns of each row, an identifier of any transformed data record that matched so that all of the identifiers of the transformed data records that matched are in the same row. If no data record identifiers are used, the first column in the table may contain the value of the matching field and the other columns are assigned to each party, with a boolean value of whether that party supplied a matching data record for that field.

It isn't necessary to provide the parties with any such indication of which transformed data records matched or did not match. As noted below, the information to be released may only include summary statistics, such as the number or percentage of each party's transformed data records that produced a match, with the actual matches not released by the third party.

A match is one form of analysis. However the data from multiple parties may be analyzed in other ways, such as a correlation between certain fields of the data records from each of the parties. For example, the parties may supply untransformed data indicating which products their customers have purchased. The identity of the products may not be ascertainable from looking at the transformed data records, but a boolean indication as to whether a given customer purchased products 0 through N may be received in the transformed data record. The analysis may include the correlation of fields in the transformed data records corresponding to customer characteristics of one party with some or all of those of another for any transformed data records that have identifier fields that match or otherwise correspond, indicating that the entity corresponding to the one or more transformed data record is the same. For example, if any one of up to ten transformed credit card numbers received for a customer in the transformed data records supplied by one party match any of up to ten transformed credit card numbers received for a customer in the transformed data records received from another party, and the sex of the customer is the same and the age range of the customer is approximately the same, the customer is considered to be the same customer and the data from each such transformed data records may be analyzed for correlation using conventional techniques. For example, it may be determined that customers who purchased product 7 of party A are highly correlated with those who purchased product 5 from party B.

A determination that the correlation between any products purchased from any two or more different parties exceeds a threshold may cause the analysis to continue to attempt to identify records that have customer characteristics that correspond to one another, indicating that the customers are the same, and for which the customer is indicated as having purchased one, but not the other correlated product. A customer identifier or record identifier corresponding to the entity from which the product has not been purchased may be appended to a list for that entity.

In one embodiment, the analysis is performed according to analysis permissions and instructions or requests provided to the party performing the analysis in steps 222, 252. The third party executes the instructions or requests in accordance with the permissions and returns the results to one or more of the parties as may be specified in the request or with the permissions. The instructions or requests given to the third party can be expressed in multiple ways, using one or more of logical, mathematical, computational, statistical, or other operators that allow arbitrarily complex analysis to be performed. Logical operators may include AND, OR, NOT (and any combination thereof). Other operators may include equals (for text, numbers or other field types, to require a match) or contains (for text, to indicate that the field includes, but is not limited to the argument). Mathematical operators may include greater than, less than, or instructions to perform mathematical operations such as addition, subtraction, multiplication, division, modulo, or other conventional mathematical functions. Statistical operators may be used to implement statistical functions such as average, mean, and other conventional statistical functions. In one embodiment, an instruction may define a function and, optionally, use it recursively. The instruction or request may perform queries, such as complex queries such as selecting all of the records that contain transform data, providing a selection criteria using one or more of the operators above, then combining that data with data from other portions of data supplied by the requester or one or more of the other parties, and/or doing statistical analysis on the result.

A short example of an analysis using various operators will now be described. In this example, the parties are: merchant 1, merchant 2, a card issuer, and a third party. In this example the two merchants supply for analysis transformed data records about transactions made by their customers using a credit card for payment. Each transformed data record contains the credit card number transformed into two parts: a bin number (which is a number), the first 6 digits of the credit card number that identifies the issuing bank; and the remaining digits of the credit card number (or the entire credit card number). The bin number, and the credit card number are encrypted using triple DES or another agreed upon encryption technique using different secrets: a bin secret used to encrypt the bin number and shared between merchant 1, merchant 2, and the card issuer, and one or more credit card secrets used to encrypt the credit card number, shared by the merchants. The dollar amount of the transaction is multiplied by Pi. An identifier of the item or items purchased is/are encrypted with a secret unique to each party and not initially shared between the parties. The zip code of the customer is not transformed. Also untransformed (or transformed) may be other identifiers such as IP address, home address, e-mail address.

Transformed data records may be provided by the merchants to the third party at any time: a batch may be provided initially and others may be provided as the transactions are received.

In this case none of the secrets are known to the third party, though in other embodiments, the third party may be privy to some or all of the secrets. As the records are received, the third party maintains, for each party, a table indexed by the transformed credit card number and maintains a count of the number of transactions for each transformed credit card number, and maintains a total of the transformed amount, average of transformed amount, and the maximum transformed value of the amount for each credit card. Additionally, the third party maintains a separate table indexed by the transformed bin number that keeps a running total of the number of transactions for that bin number.

The third party can perform analyses such as: for a given zip code, compute % of users having the same transformed credit card number that bought item X (as indicated by the transformed item identifiers) from merchant 1 and bought item Y (as indicated by the transformed item identifiers) from merchant 2. The third party can provide these results to the party to which they apply upon request.

The third party may be instructed to periodically or repeatedly run other analyses and release the results of the analysis to parties as specified by those parties or by all parties. For example, the third party may release to both merchants the matched transformed credit card number that, between both merchants: exceeds 50 transactions per day, or for which the transformed cumulated amount exceeds (PI*10,000) OR for which the average transaction exceeds ($2,000*PI). Other thresholds may be used.

The third party may be instructed by the parties that the third party has permission to release analysis results to a non-party. For example, the parties may provide permission to allow the third party to release to the card issuer the transformed bin if it exceeds 1,000 transactions per day or another threshold.

If either of the conditions are met above, whenever a transformed data record arrives with the same transformed bin or credit card number that has exceeded any threshold identified to the third party by the parties or by the non-party, the third party may return a ‘transaction potentially fraudulent’ flag or message to the merchant and identify the transformed credit card number. The information released might be an agreed upon result (or message) if a number of conditions are met. In one embodiment, different thresholds may be supplied for each statistic to the third party and different messages are supplied, with the third party returning the message corresponding to the highest threshold for the statistic, as well as the transformed credit card number. For example, a lower threshold can have an associated message that there is an 80% risk the transaction is fraudulent if the lower threshold is met, but the higher threshold is not met.

The data to be analyzed may be provided as transformed data records in a single batch, or as individual records provided continuously or nearly so, as or shortly after the data becomes available or both of these methods may be used. The analysis may be performed on the batch, as each new transformed data record is received, or both (e.g. initially as a batch and subsequently, as the transformed data records arrive.

In one example of a batch analysis, an analysis may be requested by the parties when they wish to perform a marketing campaign. The instructions for such a marketing campaign may be to have the third party calculate percentage of users that bought the product from merchant 1 identified by its transformed identifier who also bought a product identified by its transformed identifier from merchant 2. The results of this analysis may be broken down by the third party by zip code, upon instructions from the two merchants. The analysis request made to the third party may be to release statistics to both parties, without releasing to either merchant the transformed credit card identifier of a customer who has bought both products or who has bought one, but not the other product, unless both merchants instruct the third party to do so at a later time. If such a request is received by the third party from both parties, or from the party for which the product was purchased, the third party will release the transformed credit card number of such identified party. Many other types of analysis can be done, such as those based on proximity criteria, or the inference of multiple rules.

If the merchants are concerned that the third party will infer things from their data, then they can change the secrets once a month, or once a quarter (or if losing the capability to perform statistical and other analysis on a basis of more than one day is acceptable) once a day. Note that if they are concerned about such analysis at the time they change the secrets, then they can have 2 overlapping 48 hour windows where the credit card number for each transaction is transformed by each merchant using both secrets and are submitted as part of the same transformed data record at the same time. After a 24 hour window transformations using the older secret are discontinued and the data is sent with the credit card number transformed with the new secret and the credit card number transformed with an even newer secret. This technique leaves enough data for the last 24 hours to do meaningful activity caps or trend analysis.

In one embodiment, certain results of the analysis are provided by the party performing the analysis to the parties and the parties receiving the results can decide whether to release untransformed fields of the transformed data records 270, 280. In one embodiment, steps 270-278 are performed by one party and steps 280-288 are performed by another party. However, as noted below, some such steps may be omitted and some such steps may be performed by a fourth party.

In one embodiment, the transformed data records of each party may be released to all parties (or all parties except the party that supplied the transformed data recorded) by the third party to the other parties with the results. In one embodiment, only certain fields of certain transformed data records are released under certain conditions. The fields, records and conditions may be those agreed to by the parties in steps 202, 232 and communicated to the third party in steps 222, 252. In one embodiment, the information is only released according to the terms of the agreement and no other information regarding the matching or analysis of data is released by the party performing the matching or analysis or any other party.

Using the example above, the party performing the analysis may inform each pair of parties on which the analysis was performed the correlation statistics for each field on which it was performed, and may indicate to the party for which the indication that the customer already bought the correlated product exists, the identifiers of the transformed data records of each party that indicate that the customer purchased that party's product, but did not purchase the correlated product of the other party. The number of such data records may be communicated to both parties so that each side will know the number of leads the other would be providing. The parties can then agree to release the record numbers of the other party it receives as described below. Such agreement can be made in advance, in which case, the third party releases such information with the results.

As noted above, in one embodiment, as part of steps 260, 270, 280, the parties providing the transformed data records may be each notified of the records or the results of the analysis, for example, by the party performing the matching or analysis as described herein providing some or all of the parties with the table describing the matches as described above. However, in another embodiment, even this information is not provided and the party performing the matches or other analysis may provide summary statistics corresponding to the number of matches or may provide an indication of whether or not there were any matches. In still another embodiment, notification is provided regarding a range of a number of matches, e.g. 0-100, 101-500, 501-1000 or more than 1000. The type of notification may be agreed upon by the parties as part of steps 202, 232 and communicated to the party performing the matches or other analysis in steps 222, 252, which complies with the agreement but provides no other information not agreed to by the parties.

In still another embodiment, no notification of the results of the match or other analysis is provided to the parties supplying the data, and the party performing the match or analysis, which may be one of those parties or a trusted third party, does not provide the results of the analysis to any of the parties providing the transformed data records as per the agreement of the parties in steps 202, 232. Instead, the party performing the analysis may provide the results of the analysis to a fourth party agreed upon in steps 202, 232. The fourth party receives the result, and may receive untransformed fields corresponding to some or all of the transformed data records from the parties as described below.

In one embodiment, in steps 270, 280, the parties determine whether they wish to release any untransformed or transformed fields either to each other or to the fourth party. The data to be released may correspond to the matched data, the unmatched data, or both, and which of these may occur may be part of the agreement made in steps 202, 232. In one embodiment, the third party proposes the fields and records to be released in accordance with the agreement made in steps 202 and 232 and the proposal is provided with any results as part of step 260. This agreement may be communicated to the trusted third party in steps 222, 252 in order to carry out its terms.

If any records are to be released 272, 282, the records to be provided are selected 274, 284 and some or all of the untransformed data from each record selected for release is provided 276, 286, either to one or all of the other parties or to a fourth party.

In one embodiment, any data that may be provided is made part of the transformed data record, and the transformed data records from other parties may be supplied with the results. Data for which selective release is desired may be transformed, such as by encrypting it as described above. To release the data, instead of providing the data, the encryption key or keys that can be used to decrypt such data are provided. As noted above, different keys may be used to encrypt different transformed data records, and the key or keys corresponding to the transformed data records may be provided to any party to release the data encrypted therein. In other embodiments, different keys may be used to encrypt different fields, so that even selective release of individual, or groups of, fields may be made.

The untransformed data is received and processed by the party to which it was provided as described above 278, 288. A party may process the data in a variety of ways. In one embodiment, the data is processed by not providing goods or services to the entity that is the subject of a record, if for example, the match or lack of match indicated an undesirable quality of the entity, or by providing goods and services to such entity if the match or lack of match indicated a desirable quality of the entity that was the subject of the record. A party may provide, or not provide, a marketing message to the entity for which a match or correlation has been made or is lacking. A party may provide or not provide a price or benefit to an entity corresponding to a match or correlation or lack thereof. If the fourth party received the untransformed data, the fourth party may further process the data or contact the subject of each record it receives, on behalf of one or more of the parties, such as by sending communications, such as advertising or other promotional materials.

Another match or analysis request may be received 290 by the party that performs such functions. If the request is not authorized by the other parties supplying the transformed data records 292, the party that normally performs such analysis will refuse to perform the request 294. If the request is authorized by at least one other party 292, the method continues at step 260 and the request will be performed as described above, but only to the extent the request is authorized. For example, if only two of an original five parties supplying transformed data records agree to the subsequent request, only the transformed data records from those two parties will be used in the subsequent match or analysis.

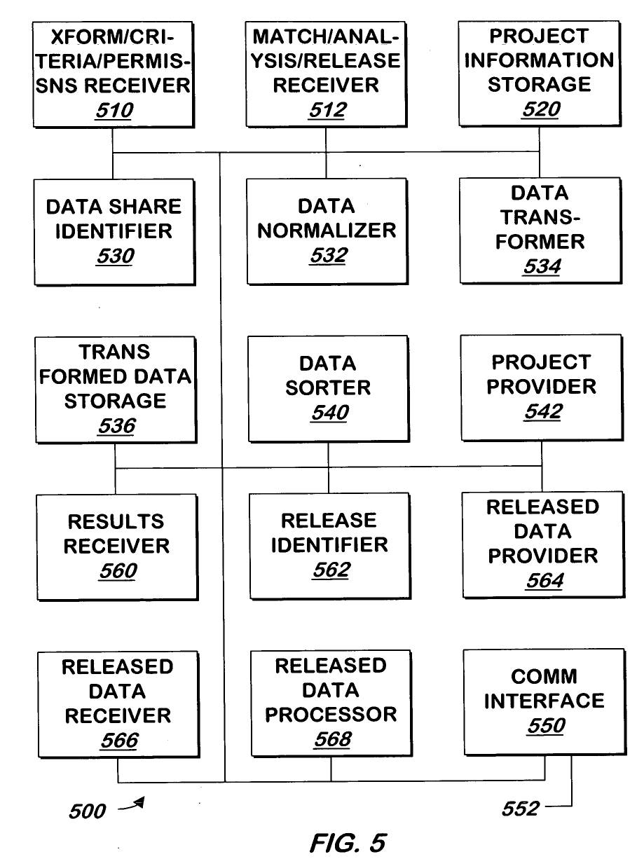

Referring now to FIG. 5 a system 500 for securely transforming and providing the transformed data for analysis with that provided by other parties, receiving results, providing some or all of the untransformed data and processing data received from other parties is shown according to one embodiment of the present invention. As described herein, the analysis can include matching or correlation, although other forms of statistical, mathematical or other analysis may be performed according to the present invention.

In one embodiment, all communications with system 500 are made via input/output 552 of communication interface 550, which may include a conventional communication interface running conventional communication protocols, including Ethernet, TCP/IP and other conventional communication protocols and may include suitable interface hardware for connection to a network such as a local area network, the Internet, or both via input 552.

The agreed upon transform information, such as an encryption or hash key to use and normalization details such as those described above, and the criteria for the data to be contributed for analysis is received from a system administrator by transform/criteria/permissions receiver 510, and such information is stored in project information storage 520. Transform/criteria/permissions receiver 510 may receive and store into project information storage 520 other information described above with reference to step 200 of FIG. 2A.

In one embodiment, transform/criteria/permissions receiver 510 also receives permission information that describes the fields on which matching or analysis is permitted, and any criteria for such matching or analysis. Permissions may include on which fields matching or analysis is permitted, and the conditions under which matching or analysis is permitted. For example, the system administrator can specify that certain designated fields may be matched or analyzed by another party provided the other party allows matching or analysis on at least half of the fields of the data it provides.

Transformation instructions are received by transform/criteria/permissions receiver 510 that describe for each field in an untransformed data record, the name of the field in the transformed data record into which such data should be stored, and any transformations that should be applied. Transform/criteria/permissions receiver 510 also receives normalization instructions that describe how to normalize each field that is to be normalized as described herein.

Details regarding any initial analyses, such as matches, to be performed on the contributed data, and any release instructions and other information described above with reference to step 202 are received from a system administrator by match/analysis/release receiver 512, which stores all such information received in project information storage 520.

A system administrator provides to data share identifier 530, the location of the data records containing data to be shared, and the fields to be added to the transformed data records, and data share identifier 530 stores the location in project information storage 520, retrieves each record corresponding to the criteria stored in project information storage 520 and provides the specified fields to each such record to data normalizer 532, which normalizes some or all of the fields in each such data record in accordance with the normalization information stored in project storage 520 and provides each such data record to data transformer 534.

When it receives each such data record, data transformer 534 transforms, as described above, some or all of the fields of the data in such record in accordance with the transformation information in project information storage 520 and provides the transformed data record to transformed data storage 536. As noted above, data share identifier 530 initiates this process for all untransformed data records specified to it. When data share identifier 530 has identified the last record to share, it signals data normalizer 532, which signals data transformer 534.

When it receives such signal, data transformer 534 signals data sorter 540, which sorts or generates, and stores in transformed data storage 536, sort indices for each field identified in project storage 536 as being a field on which a match or analysis is permitted or every field. Data sorter 540 may utilize two or more fields to break ties in each sort, such tie breaking fields being specified to match/analysis/release receiver 512 by the system administrator, such fields being agreed upon by the parties, or even selected using a predetermined criteria that is reproducible, or ties may not be broken in any consistent manner. When data sorter 540 has completed such sorting activity it signals project provider 542.

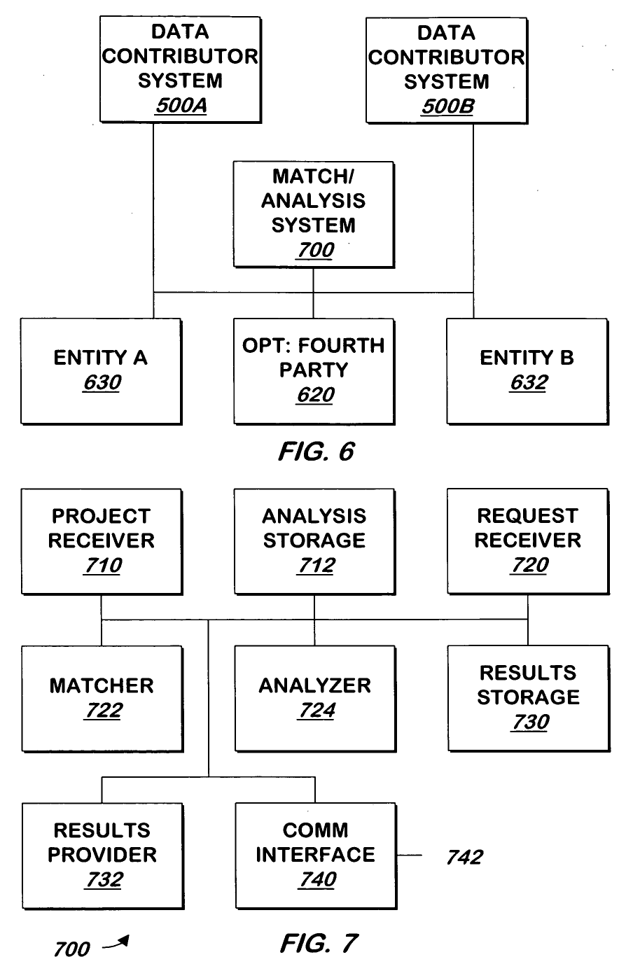

When signaled, project provider 542 provides for analysis the transformed data records, as well as the match and/or analysis instructions and permissions to either another party or to a trusted third party via communication interface 550. The trusted receiving party may receive such transformed data records and other information via the system shown in FIG. 7. The systems of FIGS. 5 and 7 are shown working together in FIG. 6, as will now be described.

Referring now to FIG. 6, a system for analyzing transformed data records from two or more parties is shown according to one embodiment of the present invention. Data contributor systems 500A, 500B are each similar or identical to the system 500 of FIG. 5. Each party contributing data to the match or analysis uses such system 500A, 500B to build and provide transformed data records and match and/or analysis instructions and permissions to match/analysis system 700 operated by a designated one of the parties or a trusted third party. The designated party or trusted third party uses match/analysis system 700 to perform the matching or analysis requested by any party in a manner consistent with the instructions and permissions provided by each party. The data contributor systems 500A, 500B and match/analysis system 700 may be coupled for all communications via a network such as the Internet, via a secure connection such as SSL or an encrypted communications session, or communications may be handled via DVD-ROM, tape, or other media shipped via conventional delivery systems or sent via private courier. Results and optionally the transformed data records may be distributed by match/analysis system 700 to data contributor systems 500A, 500B or to a fourth party processing system 620, which contains sufficient components similar to those with system 500 of FIG. 5 to receive and process the results and/or transformed data records or untransformed data corresponding to such transformed data records. Data contributor system 500A, 500B or the fourth party system 620 may communicate with entities 630, 632 in accordance with such information they receive.

Referring now to FIG. 7, a system 700 for analyzing transformed data records received from multiple parties and providing results to any one or more of such parties or to a fourth party is shown according to one embodiment of the present invention. The transformed data records and permissions and other information related to the analysis as described above from data contributor systems 500A, 500B of FIG. 6 are received by project receiver 710 and stored into analysis storage 712 by project receiver 710. Such information may be received by project receiver from the network, via input/output 742 of communication interface 740, which may be coupled to a network such as the Internet, or it may be received via a media reader such as the one described above. Communication interface 740 may be similar or identical to communication interface 550 of FIG. 5, described above.

A system administrator may user project receiver 710 to assign a project identifier and password to each set of transformed data records and permissions and other information to associate each set of transformed data records and permissions with one another, but to differentiate them from other sets of transformed data records and permissions of other projects. Although a password can be used, other embodiments may employ other means of authentication, such as encryption, message authentication codes, public/private keys or certificates, in any conventional manner. Project receiver 710 stores in analysis storage 712 the project identifier with each set of transformed data records designated by the system administrator, and stores in analysis storage 712 the password associated with the project identifier. In one embodiment, project receiver 710 provides to data contributor systems 500A, 500B the project identifier and password in encrypted form in response to the transformed data records it receives so that subsequent analysis instructions may be received. Referring momentarily to FIG. 5, project provider 542 may receive the project identifier and password and store them into project information storage 520. The system administrator of the system 500 may use a user interface provided by match/analysis/release receiver 512 to decrypt the project identifier and password. In one embodiment, along with the other information provided by each party as described above, each party provides its public key to its own match/analysis/release receiver 512, which stores such key into project information storage 520. Project provider 542 provides the public key with the other information it provides, and such public key is used to encrypt the information provided to that party.

Referring again to FIG. 7, as project receiver 710 receives the transformed data records, permissions and other information from the parties, it notifies the system administrator via a user interface it provides. When all of the transformed data records have been received from the parties, the system administrator signals project receiver 710 via the user interface it provides, and project receiver 710 provides the project identifier to request receiver 720.

Request receiver 720 receives the project identifier, and scans analysis storage 712 for any match or other analysis requests that were received as part of the information received with the transformed data records. If it finds one, it checks the permissions corresponding to the other parties in the request. Request receiver 720 performs the analysis request to the extent that the permissions permit the request to be performed as described above. In one embodiment, an inherent permission is that a provider of a request may only match or analyze data between the transformed data records it provided and one or more other parties. If the permissions do not allow the request to be performed at all, request receiver 720 refuses to perform the request. In one embodiment, request receiver 720 notifies the requester the extent to which the request cannot be performed and asks the requester whether it should continue. If the requester assents, request receiver 720 performs the request. In the case in which the request was received with the transformed data records, the requestor is reached by request receiver 720 providing via communication interface 740 and communication interface 550 to project provider 542 such notification and receiving a response in the opposite path.

To perform a match request involving the detection of the presence of absence of a match, in one embodiment, request receiver 720 provides the match request to matcher 722, which performs the request as described above, generates the results as described above, stores the results in results storage 730 and signals request receiver 720 with an identifier of the data structure into which the results were stored.

If an analysis is requested that requires detecting the presence or absence of a match, plus additional analysis, such as was described in the correlation example above, request receiver 720 first builds a match request corresponding to the analysis and provides the request it builds to matcher 722, which performs the request, stores the results into results storage 730 and signals request receiver 720 with the identifier of the data structure into which the results were stored. Request receiver 720 then provides the analysis request and the identifier of the data structure to analyzer 724, which uses the data structure having the identifier it receives in order to perform the request, stores the results into a data structure in results storage 730 and provides an identifier of the data structure to request receiver 720.

If additional match requests are required, request receiver 720 builds any such request and provides it to matcher 722, which performs the request and signals request receiver 720 as described above. This process can be repeated any number of times, with matcher 722 being used to detect the presence or absence of a match and analyzer 724 being used for all other analysis functions. If an analysis request may be performed without first performing a match, request receiver 720 provides the request to analyzer 724, which performs the request, stores the results in results storage 730 and signals request receiver with an identifier of the data structure in which it stored the results. The results may include any or all of summary statistics, tables that include references to the transformed data records provided by the party that correspond to the analysis as described above, and the transformed data records from all parties or the other parties that correspond to the request (e.g. transformed data records having a field that matched a specified field of the transformed data records of the party that provided the request).

When signaled, when the request is complete, request receiver 720 provides the identifier of the data structure containing the results and the identifiers of the parties that are to receive the results to results provider 732. The type of results to be provided may be specified with the permissions received as described above, and so request receiver 720 uses such permissions in providing the results. As noted below, the request may be made by a system administrator, and such request may include a description of the information to be included in the results, and such description is used by request receiver to cause the results it provides to be consistent with the description. In one embodiment, the parties are specified in the request, and in another embodiment, the parties that receive the results are all parties corresponding to the transformed data records that were used in fulfilling the request, or in another embodiment, all of the parties associated with the project. Results provider 732 formats the results and provides the results to the parties having the identifiers it receives. In one embodiment, results provider 732 provides results by encrypting them and then e-mailing them via communications interface 740, which forwards them via input/output 742 to a network such as the Internet. In one embodiment, either communications interface 550, 740 also includes the capability to read and write media such as a conventional CD-ROM or DVD-ROM and communication of transformed data records and permissions and the results are made via such media.

If there are additional analysis requests that had been provided with the transformed data records, request receiver 720 selects the next such request and repeats the process described above using that request.

Additional requests may be received from a system administrator, or from one of the parties supplying the transformed data records, using the password such party receives as described above. If the system administrator supplies the request, it includes the project identifier may include an identifier of the party from which the request was received. In such cases, request receiver 720 receives the request, authenticates the user, and identifies the project containing the transformed data records and permissions from the various parties participating in the project. Request receiver 720 then processes the request and initiates the providing of the results as described above.

As described above, the results of each analysis request are provided to results receiver 560. Results receiver 560 receives the results via communications interface 550 (either via the Internet or via a removable media) and stores the results into project information storage 520.

In one embodiment, additional information is released as a result of the analysis request. In one such embodiment, approval is required before any additional information is released, and so results receiver 560 signals release identifier 562 with an identifier of the location of the results. Results receiver 560 may also display the results so received via a user interface it displays in the event that no further approval to provide additional information in response to the results is needed.

In one embodiment, when it is signaled, release identifier 562 allows a system administrator to display the results and identify whether some or all of the untransformed information corresponding to the results should be released. This may include untransformed fields of the transformed fields in the transformed data records that matched or did not match or other information that was not originally provided as part of the transformed data records.

In one embodiment, the request that is provided as described above contains information regarding the information that should be released (e.g. field names corresponding to contact information) as well as the circumstances under which the release is desired (e.g. records that matched or correlated or records that did not match or did not correlate) and the parties to whom release is desired. Such information is passed to results provider 732 by request receiver 720, provided with the results, and displayed by release identifier 562. A system administrator of the party may indicate that some or all of such information is acceptable to release, and if some of the information is acceptable, may designate the fields or records that are acceptable to release via a user interface displayed by release identifier 562 and the parties to whom the release is acceptable. Release identifier 562 marks the records and/or fields identified by the system administrator. In one embodiment, the results are displayed by release identifier 562 to allow the system administrator to make its release decisions based on the results.

In one embodiment, the party or parties to whom the approved fields from the approved untransformed data records will be released are also displayed for approval by the system administrator, and the system administrator may approve some or all of the parties. Such parties may be supplied with the results, such parties having been identified by the party supplying the transformed data records or request.

In one embodiment, the release is automatically handled according to the release criteria stored in project information storage 520 described above. In one embodiment, the criteria may include the number or percent of matches, or degree of correlation received with the results that corresponds to each of the parties to whom the release would be made. In one embodiment, the criteria may include other information, such as the number of transformed data records each of the parties to whom the data will be released has contributed, and whether (or the number or percentage of time) that party has agreed to the decision-making party's prior requests such information being provided with the results. In such embodiment, release identifier 562 automatically indicates the untransformed data records, and fields within such records, to release. In one embodiment, an indicator of fields within each record that may be released are indicated by the system administrator to match/analysis/release receiver 512 and such information is stored in project storage 520. Release identifier 562 only identifies for release those fields that are so indicated, with the other fields to only be released manually as described above. In such embodiment, release identifier 562 may prepare the fields and records for automatic release by providing a data structure into project storage 520 indicating the untransformed data records and fields within each of the untransformed data records to be released, but receive approval for such release after displaying the fields and an optionally allowing the display of each of the records or the number of records to a system administrator for approval. If approval is required, when the approval is received, (and if approval is not required, automatically, in one embodiment), release identifier 562 provides an identifier of the data structure to released data provider 564.

When it receives the identifier of the data structure, released data provider 564 retrieves from that location, and provides, the indicated fields from the untransformed data records according to the data structure having the identifier it received. The untransformed data records are stored external to system 200 in one embodiment, their location having been stored in project information storage 520 as described above. In one embodiment, released data provider 564 provides the indicated fields from the indicated untransformed data records to all of the parties approved by the system administrator or release identifier 562 and stored in project information storage 520. In one embodiment, released data provider 564 so provides by encrypting the information from the untransformed data records in a manner that allows their decryption by the recipient, for example, using a shared, secret key all the parties share and store in project information storage 520 via match/analysis/release receives 512 and sends such data records to the other party or parties via communication interface 550. In another embodiment, released data provider 564 encrypts and provides such data via a media, such as a DVD-ROM that communication interface 550 is capable of producing. The media is then sent to the other party by mail or courier.

The data is received by released data receiver 566 of the other parties via their communication interface 550 and stored in project information storage 520. In the event that the data is encrypted, the data is decrypted by released data receiver 566 using a shared secret key such as that stored in project information storage 520 as described above and the conventional encryption protocol and parameters used to encrypt the data, such as triple DES. When released data receiver 566 has completed optionally decrypting and storing the released data, released data receiver 566 signals released data processor 568 with the storage location of the released data.

When so signaled, released data processor 568 processes the data as described above. Processing data may be performed by contacting a customer, providing or refusing to provide goods or services such as credit, awarding a prize or reward, or any other means of processing data related to an entity.

In one embodiments the system of FIG. 5 may be provided as separate components. Elements 510-542 may be provided separately from elements 560-568, with each component having its own communication interface similar or identical to communication interface 550 and project information storage 520, with some or all of the information therein transferred between the two. The fourth party may have a system containing elements 550, 566, 568 and optionally results receiver 560 to process the released data.

What is claimed is:

1. A method of analyzing data from a plurality of parties, the method comprising:
receiving a plurality of records from each of the plurality of parties, each of the records comprising transformed data that at least obscures a value of the transformed data when decoded by a computer system; and
performing an analysis on at least a portion of at least one of the plurality of records received from each of the plurality of parties, in which the analysis comprises an analysis other than matching at least a portion of said at least the portion of at least one of the plurality of records from each of the plurality of parties.

2. The method of claim 1:
additionally comprising receiving at least one permission from at least one of the plurality of parties; and
wherein the performing the analysis step is responsive to the at least one permission received.

3. The method of claim 2, additionally comprising:
receiving at least one request for analysis; and
refusing to comply with the at least one request for analysis request received, responsive to the at least one permission received.

4. The method of claim 1, wherein the performing the analysis step additionally comprises matching at least a second portion of said at least one of the plurality of records from each of the plurality of parties, said second portion being selected from the group comprising the first portion and a portion different from the first portion.

5. The method of claim 1, additionally comprising releasing information responsive to the analysis responsive to instructions agreed upon by each of the plurality of the parties.

6. The method of claim 5, wherein the releasing the information comprises:
releasing, responsive to instructions received before the analysis, summary information regarding the analysis to all of the plurality of parties;
receiving additional instructions responsive to the releasing of the summary information; and
releasing data from at least one of the plurality of parties to at least one other of the plurality of parties responsive to the additional instructions.

7. The method of claim 1, wherein each of the records in the plurality comprises at least one field transformed in a consistent manner by each of the plurality of the parties.

8. The method of claim 7, wherein a portion of the records in the plurality of one of the parties in the plurality are transformed in a manner that does not allow analysis with the remaining records in the plurality.

9. The method of claim 8 wherein the portion of the records transformed in the manner that does not allow analysis with the remaining records in the plurality are transformed to allow analysis with a plurality of records of a different party.

10. The method of claim 1, wherein at least a portion of each of the records in the plurality are transformed by encryption with a first key to produce a result, and encryption of the result with at least one second key, different from the first key.

11. The method of claim 1, wherein the analysis is performed as part of providing a reward.

12. The method of claim 1, wherein the analysis is performed to detect fraud.

13. The method of claim 12, wherein the fraud comprises financial fraud.

14. A system for analyzing data from a plurality of parties, the system comprising:
a project receiver having an input operatively coupled for receiving a plurality of records from each of the plurality of parties, each of the records comprising transformed data that at least obscures a value of the transformed data when decoded by a computer system, the project receiver for providing at an output at least one of the plurality of records from each of the plurality of parties; and
a matcher/analyzer having an input coupled to the project receiver output for receiving the at least one of the plurality of records from each of the plurality of parties, the matcher/analyzer for performing an analysis on at least a first portion of least one of the plurality of records received from each of the plurality of parties, in which the analysis comprises an analysis other than matching the at least the first portion of said at least one of the plurality of records from each of the plurality of parties, and for providing at least one result of said analysis at an output.

15. The system of claim 14, wherein:
the project receiver input is additionally for receiving at least one permission from at least one of the plurality of parties, and the project receiver is additionally for providing the at least one permission at the project receiver output;
the matcher/analyzer additionally receives the at least one permission at the matcher/analyzer input; and the matcher/analyzer performs the analysis responsive to the at least one permission received.

16. The system of claim 15, wherein:
the project receiver input additionally receives at least one request for analysis;
the project receiver is additionally for providing the at least one request for analysis at the project receiver output;
the matcher/analyzer input is additionally for receiving the at least one request for analysis; and
the matcher/analyzer is additionally for refusing to comply with the analysis request received, responsive to the at least one permission received.

17. The system of claim 14, wherein the matcher/analyzer is additionally for matching at least a second portion of said at least one of the plurality of records from each of the plurality of parties, said second portion being selected from the group comprising the first portion and a portion different from the first portion.

18. The system of claim 14:
wherein the project receiver is additionally for receiving at the project receiver input and providing at the project receiver output, at least one permission agreed upon by each of the plurality of the parties;
additionally comprising a results provider having an input coupled to the matcher/analyzer output for receiving the at least one result of the analysis and to the project receiver output for receiving the at least one permission, the results provider for releasing information responsive to the analysis responsive to the at least one permission.

19. The system of claim 18, wherein:
the at least one permission is received by the project receiver before the analysis:
the results provider receives at least one instruction after the analysis; and
the results provider releases at least one selected from the information responsive to the analysis and additional information responsive to the analysis responsive to the at least one instruction.

20. The system of claim 14, wherein each of the records in the plurality comprises at least one field transformed in a consistent manner by each of the plurality of the parties.

21. The system of claim 20, wherein a portion of the records in the plurality of one of the parties in the plurality are transformed in a manner that does not allow analysis with the remaining records in the plurality.

22. The system of claim 21 wherein the portion of the records transformed in the manner that does not allow analysis with the remaining records in the plurality are transformed to allow analysis with a plurality of records of a different party.

23. The system of claim 14, wherein at least a portion of each of the records in the plurality are transformed by encryption with a first key to produce a result, and encryption of the result with at least one second key, different from the first key.

24. The system of claim 14, wherein the analysis is performed to provide a reward.

25. The system of claim 14, wherein the analysis is performed to detect fraud.

26. The system of claim 25, wherein the fraud comprises financial fraud.

27. A computer program product comprising a computer useable medium having computer readable program code embodied therein for analyzing data from a plurality of parties, the computer program product comprising computer readable program code devices configured to cause a computer system to:
receive a plurality of records from each of the plurality of parties, each of the records comprising transformed data that at least obscures a value of the transformed data when decoded by a computer system; and
perform an analysis on at least a portion of at least one of the plurality of records received from each of the plurality of parties, in which the analysis comprises an analysis other than matching at least a portion of said at least the portion of at least one of the plurality of records from each of the plurality of parties.

28. The computer program product of claim 27:
additionally comprising computer readable program code devices configured to cause the computer system to receive at least one permission from at least one of the plurality of parties; and
wherein the performing the analysis step is responsive to the at least one permission received.

29. The computer program product of claim 28, additionally comprising computer readable program code devices configured to cause the computer system to:
receive at least one request for analysis; and
refuse to comply with the at least one request for analysis request received, responsive to the at least one permission received.

30. The computer program product of claim 27, wherein the computer readable program code devices configured to cause the computer system to perform the analysis additionally comprise computer readable program code devices configured to cause the computer system to match at least a second portion of said at least one of the plurality of records from each of the plurality of parties, said second portion being selected from the group comprising the first portion and a portion different from the first portion.

31. The computer program product of claim 27, additionally comprising computer readable program code devices configured to cause the computer system to release information responsive to the analysis responsive to instructions agreed upon by each of the plurality of the parties.

32. The computer program product of claim 31, wherein the computer readable program code devices configured to cause the computer system to release the information comprise computer readable program code devices configured to cause the computer system to:
release, responsive to instructions received before the analysis, summary information regarding the analysis to all of the plurality of parties;
receive additional instructions responsive to the releasing of the summary information; and
release data from at least one of the plurality of parties to at least one other of the plurality of parties responsive to the additional instructions.

33. The computer program product of claim 27, wherein each of the records in the plurality comprises at least one field transformed in a consistent manner by each of the plurality of the parties.

34. The computer program product of claim 33, wherein a portion of the records in the plurality of one of the parties in the plurality are transformed in a manner that does not allow analysis with the remaining records in the plurality.

35. The computer program product of claim 34 wherein the portion of the records transformed in the manner that does not allow analysis with the remaining records in the plurality are transformed to allow analysis with a plurality of records of a different party.

36. The computer program product of claim 27, wherein at least a portion of each of the records in the plurality are transformed by encryption with a first key to produce a result, and encryption of the result with at least one second key, different from the first key.

37. The computer program product of claim 27, wherein the analysis is performed as part of providing a reward.

38. The computer program product of claim 27, wherein the analysis is performed to detect fraud.

39. The computer program product of claim 38, wherein the fraud comprises financial fraud.

40. A method of providing data for analysis while controlling its release, the method comprising:
receiving from one party information regarding a transformation of the data, said information also used to transform data from another party;
transforming the data in a manner that facilitates analysis of the data without disclosing all of the data transformed; and
providing the transformed data for purpose of analysis with data transformed by said another party.

41. A computer program product comprising a computer useable medium having computer readable program code embodied therein for providing data for analysis while controlling its release, the computer program product comprising computer readable program code devices configured to cause a computer system to:
receive from one party information regarding a transformation of the data, said information also used to transform data from another party;
transform the data in a manner that facilitates analysis of the data without disclosing all of the data transformed; and
provide the transformed data for purpose of analysis with data transformed by said another party.
